(19) United States
(12) Patent Application Publication
(10) Pub. No.: US 2026/0120693 A1
(43) Pub. Date: Apr. 30, 2026

(54) DECLARATIVE AGENT WITH VOICE AGENT LATENCY MITIGATION

(71) Applicant: Sierra Technologies, Inc., San Francisco, CA (US)

(72) Inventors: Julien Zachary Reneau-Wedeen, San Francisco, CA (US); Mihai Parparita, Cupertino, CA (US); Julie Christina Tung, Los Altos, CA (US); Bret Steven Taylor, Lafayette, CA (US); Andrew Joseph Timmons, Emeryville, CA (US); Stephan Dominique Walter Zuercher, San Francisco, CA (US)

(21) Appl. No.: 19/368,509

(22) Filed: Oct. 24, 2025

Related U.S. Application Data
(60) Provisional application No. 63/712,122, filed on Oct. 25, 2024.

(51) Int. Cl. G10L 15/22; G10L 15/183; G10L 15/34

(52) U.S. Cl. CPC G10L 15/22; G10L 15/183; G10L 15/34

(57) ABSTRACT

A system receives a voice input from a user during a real-time conversation between an agent and the user. The system identifies a set of foreground processing triggers and a set of background processing triggers. The system performs a foreground processing action based on the set of foreground processing triggers to generate a first response and a background processing action based on the set of background processing triggers to generate a second response. The system presents the first response to the user in response to the voice input. In response to receiving the second response while the first response is presented to the user, the system modifies the first response in real-time to integrate the second response before finishing the presenting of the first response.

### CROSS REFERENCE TO RELATED APPLICATION

This application claims the benefit of U.S. Provisional Application No. 63/712,122, filed Oct. 25, 2024, which is herein incorporated by reference in its entirety.

### TECHNICAL FIELD

The disclosure generally relates to the field of artificial intelligence, and more specifically relates to a declarative agent using machine learning models.

### BACKGROUND

Agents are software that coordinate sequences of interactions with AI (artificial intelligence), such as LLMs (large language models) and external software systems. Voice-based conversational agents are increasingly utilized in various interaction scenarios. In voice-based conversational AI, latency refers to the time it takes for an agent to receive a voice input, process it, and deliver an appropriate response. High latency can lead to awkward pauses, misunderstandings, and a generally poor user experience, making it critical for voice agents to respond promptly. However, generating a well-informed and contextually relevant response often requires complex processing, multiple LLM invocations, and network requests, which can each introduce delays. A key challenge in managing latency is to balance performing tasks that require immediate responses along with those that necessitate deeper processing. For example, misclassifying a user request can lead to the wrong processing being triggered, which may result in either overloading the deeper processing with simple queries or the immediate response providing incomplete responses for complex input. Additionally, an integration of the fast response with the deeper processing is also crucial for maintaining the consistency of the conversation.

### SUMMARY

Systems and methods are disclosed herein that mitigates latency in responses during voice conversations between a user and an agent, which is crucial for maintaining a smooth and natural interaction. In this disclosure, latency is minimized by processing the voice input through multiple parallel streams, allowing the system to provide an initial response quickly while performing more in-depth processing simultaneously. Machine learning (ML) models may be employed to classify triggers in voice inputs, determining when to activate foreground and background processing streams. By using foreground processing streams for quick initial responses and background processing stream for deeper analysis, the system provides timely and relevant feedback, enhancing the overall user experience while maintaining high-quality, contextually aware interactions.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing a declarative agent service.

FIG. 2 illustrates one embodiment of modules of the declarative agent service.

FIG. 3 is a flowchart for a method of generating a response to a voice input with parallel processing streams.

FIG. 4 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

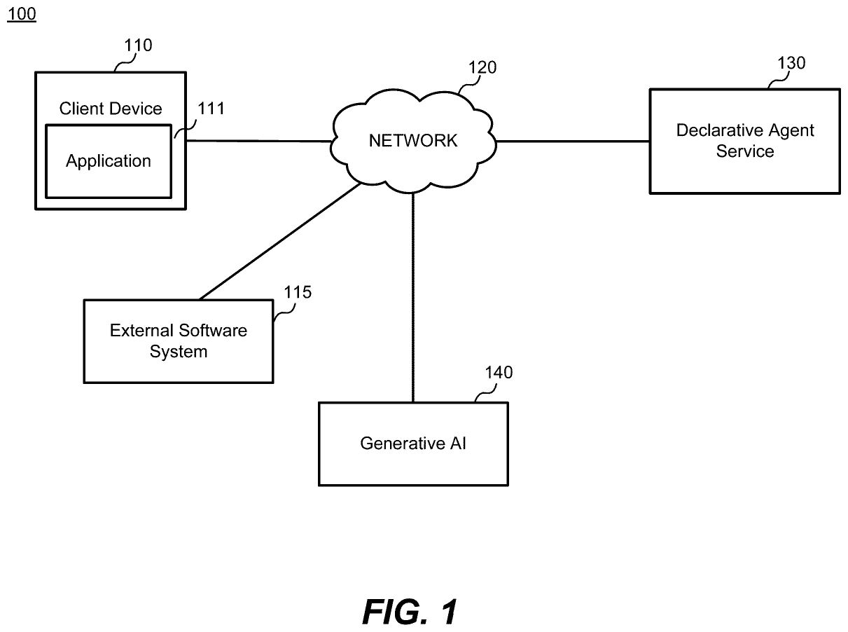

FIG. 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone or feature phone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk).

Alternatively or additionally, application 111 may be a browser through which declarative agent service 130's functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

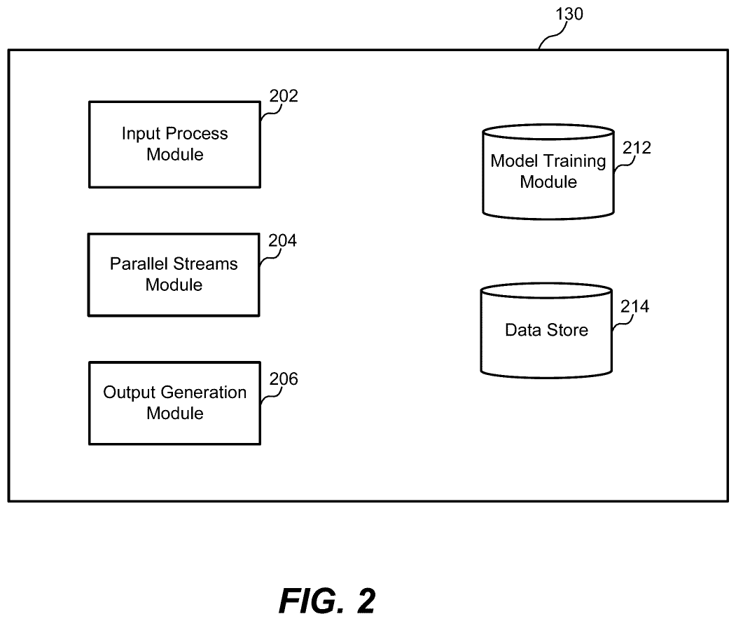

Declarative agent service 130 is used by client devices 110 and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of the policy enforcement service. As depicted in FIG. 2, the declarative agent service 130 includes an input processing module 202, a parallel streams module 204, an output generation module 206, a model training module 212, and a data store 214. These modules and databases are merely illustrative; fewer or more modules and/or databases may be used to achieve the functionality disclosed herein.

The input processing module 202 receives voice inputs from a user in a conversation between the user and an agent of the declarative agent service 130, and monitors for triggers in real-time to determine when to activate foreground and/or background processing streams. The triggers are used to indicate which actions the agent need to take to keep the conversation fluid and which actions require deeper analysis or additional resources that need to be processed in parallel without delaying the immediate response.

In some embodiments, the input processing module 202 may perform a pre-processing on the received voice inputs. For example, when a voice input is received from a user, the input processing module 202 may analyze the audio signal and convert it into text. In some implementations, the input processing module 202 may use automatic speech recognition (ASR) to transcribe spoken words into a digital text format that the declarative agent service 130 can further process. The input processing module 202 may normalize the transcribed text data to refine the text output. For instance, the input processing module 202 may remove unnecessary elements such as filler words (“um,” “uh,” etc.) and irrelevant noises (e.g., “coughs,” “laughter,” etc.). The input processing module 202 may split the text into individual words or tokens and standardizing formats, such as converting numbers from words to numerals or expanding contractions. In some embodiments, the pre-processed text may be used to generate input to a machine learning model for determining triggers of actions. For example, the text may be transformed into features that the machine learning model can process.

The input processing module 202 monitors for triggers that determine the actions in the parallel streams processing. Triggers are specific cues or conditions identified in the transcribed text (or the audio input) that prompt the agent to activate foreground and/or background processing streams in the parallel stream processing. In some embodiments, the triggers may be pre-defined based on the declarative agent service 130's targets and/or client's requirements and preferences. The triggers may include content-based triggers, contextual triggers, sentiment-based triggers, and the like. The content-based triggers may be identified based on the content of the voice input. The input processing module 202 may identify the content-based triggers based on keywords, phrases, or patterns that indicate a particular type of query or request. For instance, if a user says, “I need help with my account settings,” the keywords “help” and “account settings” may trigger the foreground processing stream to provide an immediate response or ask a follow-up question. The input processing module 202 may identify content-based triggers by recognizing the intent behind the user's words. In some implementations, the input processing module 202 may apply machine learning models, such as natural language understanding (NLU) and the like, to infer intent from the phrasing and context. For example, recognizing an intent to “reset a password” may trigger both a quick response to confirm the action and a background process to authenticate the user and prepare the password reset mechanism. In some embodiments, the input processing model 202 may use the input to generate a prompt to a large language model (LLM). The prompt may include the user input and a request to predict user intention based on the user input. The input processing model 202 may provide the generated prompt to the LLM and receive an output including a predicted user intent.

In some embodiments, the input processing module 202 may identify contextual triggers which take into account the broader context of the conversation, including previous interactions, the user's history, situational cues, etc. These triggers may indicate that the declarative agent service 130 need to access additional information to understand the ongoing conversation's relevance and adjust the processing streams accordingly. In some examples, the contextual triggers may be associated conversation history. For example, if a user is discussing a complex issue, the input processing module 202 may identify a trigger for the background processing stream to fetch relevant data or escalate the query to a human agent. In one example, after a long conversation about billing issues, the user may input “What about my last payment?” In this case, the input processing module 202 may identify a trigger for the background processing stream to retrieve detailed payment history while keeping the user engaged. In some embodiments, the input processing module 202 may identify contextual triggers that are associated with user profile, including such as the user's previous behavior, preferences, or account status, etc. For example, a VIP user asking for “technical support” might automatically trigger a background processing stream to prioritize and expedite the request.

In some embodiments, the input processing module 202 may identify sentiment-based triggers based on tones and sentiment of the user's voice input. In some implementations, during pre-processing, the input processing module 202 may use sentiment analysis tools to evaluate the emotional tone in real time, such as frustration, anger, or satisfaction. If the input processing module 202 detects negative sentiment (e.g., a frustrated tone or words like “upset,” “angry,” or “not working”), the input processing module 202 may trigger a background processing stream to escalate the case to a human agent while simultaneously providing soothing, immediate feedback to the user through the foreground processing stream.

In some implementations, the input processing module 202 may use keyword matching to identify the triggers in the user input. For example, the input processing module 202 may pre-define the conditions or events that may act as triggers, such as keywords, key phrases, data values, etc. The input processing module 202 may store a list of the pre-defined triggers. When a user input is received, the input processing module 202 may pre-process the user input and generate a list of tokens/strings and compare the list of tokens/strings with the list of the pre-defined triggers to identify the triggers. After matching the user input with a keyword or phrase, the input processing module 202 maps the keyword/phrase to a particular response or function to generate a response to the user input. If multiple keywords are detected in the same query, priority rules may be used to determine which action to trigger first. For example, a query like “I need to get a refund and cancel my order” would know to prioritize the “cancel my order” intent before proceeding to help the customer process their refund, if that was the desired ordering.

In some implementations, the input processing module 202 may use a rule-based pattern to identify triggers in a user input. These patterns may represent complex information such as dates, order numbers, or phone numbers, allowing the declarative agent service 130 to handle diverse input formats. The input processing module 202 may pre-define rules or regular expressions to detect more structured patterns in user input. For example, the patterns may be common structures found in user queries, such as “Order #12345,” which can be captured using a regular expression like “Order\s #\d{5}.” Rules may be used to detect commonly structured phrases, such as “I want to [action].” When receiving a user input, the input processing module 202 may use the pre-defined patterns to identify triggers. For example, the input processing module 202 identifies an order number using the pattern Order #\d{5}, and generates a response based on the pre-defined rules.

In some embodiments, the input processing module 202 may use a machine learning model (e.g., Generative AI 140) to identify the triggers in the user input. In some implementations, the machine learning model may be an LLM or a fine-tuned LLM. The machine learning model may be a supervised machine learning model that is trained on a labeled dataset where each input (e.g., user query) is associated with specific labels (e.g., intents, entities, or actions). The model learns from these training examples to generalize and make predictions on new, unseen data. In some implementations, the input processing module 202 may generate a training dataset by gathering user queries, historical conversations, user feedback, etc. For example, the input processing module 202 may extract queries from historical chat logs where users have previously interacted with either an agent of the declarative agent service 130 or human agents. In some examples, simulated/generated data may be created and used as training examples. The training dataset may include a wide range of query types, including different user intents. Each training example may be labeled with the corresponding trigger. For example, queries like “Where is my order?” or “Can you track my shipment?” would be labeled with the “Track Order” intent, while queries like “I want a refund” or “How can I get my money back?” would be labeled as “Refund Request.” In some implementations, a training example may include additional labels indicating features/parameters of the user query, such as dates, order numbers, product names, and the like.

To train the machine learning model with the training dataset, the input processing module 202 may define an objective function, which guides the model in learning to predict the correct triggers from user queries. In some implementations, the model is trained to classify the user queries into different categories of triggers, and a cross-entropy loss may be used as the objective function. This loss function measures the difference between the model's predicted probabilities and the actual labels, guiding the optimization of the model's parameters. During the training process, the model may be applied to the training examples, and based on the measured loss, the model's weights may be adjusted during training to reduce the loss function and improve the model's predictions. The training process involves feeding the training data into the model, which iteratively updates its weights based on the feedback from the loss function. For neural networks, this training is often conducted over multiple epochs, with each epoch representing a complete pass through the training dataset. Once the model is trained, when receiving a new user input, the input processing module 202 may apply the trained machine learning model to the user input and output one or more triggers and/or the associated actions.

In some implementations, feedback on response output from the machine learning model may be collected to update/retrain the model. For example, if users correct the responses or indicate that the agent misunderstood their query, this information may be used as feedback. In some implementations, humans may review the generated response to evaluate the model's accuracy and identify any recurring issues. Based on the feedback analysis, the input processing module 202 may update the training dataset to include new examples, corrections, or additional variations of existing queries that reflect the identified issues. The input processing module 202 may adjust the models in its architecture, hyperparameters, or training approach based on the feedback. For instance, if the feedback indicates a frequent misunderstanding of certain phrases, updating the training dataset to include these examples and retraining the model with examples of these phrases may improve accuracy. In some cases, incremental learning techniques may be applied, allowing the model to be updated with new data without requiring a full retrain from scratch.

In some implementations, the input processing module 202 may process the user's input in real time as receiving the user input. The input processing module 202 may input the received voice command and/or transcribed text into the trained machine learning model and output one or more triggers and the associated actions. For example, the input processing module 202 may start to process a partial user input before the user completes a whole query to reduce the time to generate a response to the user query. In one instance, a user may input “where is . . . ,” and before the user completes the whole sentence, the input processing module 202 may predict one or more triggers that may be included in the user query, e.g., “Track Order,” “Request Information,” etc. The input processing module 202 may use the trained machine learning model to predict the triggers based on the partial user input and output a confidence score with each predicted trigger. The confidence score may indicate a likelihood that the user's query includes the predicted trigger. In some implementations, the confidence score may be determined based on the context of the user input, user data, historical conversations, etc. The input processing module 202 may dynamically output the predicted trigger as receiving subsequent user input. When the confidence score exceeds a certain threshold, the input processing module 202 may transmit the predicted one or more triggers to the parallel streams module 204 for generating a response.

In some implementations, the input processing module 202 may use a model to auto-complete a partial input in a few directions and determine the triggers in the different directions while the user is finishing sentences. For example, upon receiving a user's input “where is . . . ,” the input processing module 202 may input the partial user input and auto-complete the sentence, such as “where is my order?”, “where is your local store?” and the like. For the auto-completed sentence “where is my order?”, the input processing module 202 may determine the associated trigger is “Track Order” and the associated confidence score may be 0.57; and for the auto-completed sentence “where is your local store?” the input processing module 202 may determine the associated trigger is “Request Information” and the associated confidence score 0.43. The input processing module 202 may transmit the predicted triggers to the parallel streams module 204 for preparing responses.

In some implementations, the input processing model 202 may use a machine learning model (e.g., an LLM or a fine-tuned LLM) to predict a set of triggers and transmit the set of triggers to the parallel streams module 204 and output generation module 206 to generate a set of candidate responses. Each candidate response may correspond to one or more of the set of triggers. The declarative agent service 130 may continuously monitor the input and identify triggers to determine the user's intent in real time. Once the declarative agent service 130 identifies the trigger for determining the user intent, the declarative agent service 130 may present the corresponding candidate response to the user with zero latency.

The parallel streams module 204 receives the identified triggers and/or the associated actions and determines the processing streams based on the triggers. The parallel streams module 204 may determine a foreground processing action when the triggers indicate an immediate and/or basic response. For example, certain content-based triggers may be associated with foreground processing stream. These triggers may indicate straightforward, common tasks or simple queries, e.g., “What's the weather today?” or “Transfer $50 to my savings account.” These tasks are usually quick to process and do not require extensive background information.

The parallel streams module 204 may determine a background processing stream based on the identified trigger which indicates deeper, more complex analysis or additional information retrieval is needed. For instance, if a user asks for a detailed account statement or technical troubleshooting, these tasks require accessing multiple data sources or running complex algorithms, which are better suited for background processing streams. Similarly, triggers indicating high emotion (e.g., sentiment-based triggers) or context-sensitive actions (e.g., contextual triggers) may activate background processing streams to gather additional information or escalate to a human agent.

In some embodiments, the parallel streams module 204 may determine to activate both the foreground processing stream and the background processing stream in parallel so that the declarative agent service 130 may perform more intensive tasks without delaying the immediate response. For example, if a user requests something that needs immediate acknowledgment but also requires additional information retrieval (e.g., “I need help with a charge on my card”), the parallel streams module 204 may determine to activate the foreground processing stream to give an immediate response, such as confirming receipt of the query; and activate the background processing stream to perform a deeper investigation, such as accessing a database to retrieve user history and preference, etc.

In some implementations, the parallel streams module 204 may define a set of rules to determine which processing stream to activate. The parallel streams module 204 may establish criteria that differentiate between the foreground processing stream and the background processing stream based on complexity, response time, etc. For example, a user query that involves several steps or ambiguity, or requires additional context, may be determined to activate a background processing stream. In one example, the parallel streams module 204 may determine the stream based on the category of the trigger/actions. For instance, a trigger of “Request Information” may be associated with a simple query, and used to activate the foreground processing stream. In another example, the parallel streams module 204 may determine the number of triggers/categories included in a user query. If the number of triggers exceeds a threshold number, the background processing stream may be activated. For example, a user inputs, “I want to know if my package has arrived, but I misplaced the tracking number and need help finding it.” In this case, there are at least two triggers/categories, “Track Order” and “Request Information,” and the parallel streams module 204 may determine the number of triggers/categories exceeds a threshold number (e.g., 1) and determine to activate the background processing stream.

In some implementations, the parallel streams module 204 may use a machine learning model to determine which processing stream to activate. For example, the machine learning model may be trained to predict a processing time to generate the response. If the predicted processing time exceeds a threshold time, the parallel streams module 204 may determine that a background processing stream is needed. For example, the parallel streams module 204 may pre-determine a threshold time between the user's voice input and the response provided by the agent, e.g., 1 second, 2 second, etc. If the time for an agent to provide a response to a user input from the time that the agent receives the user input is longer than the threshold time, the declarative agent service 130 may determine that a latency is introduced. To avoid/mitigate latency, the parallel streams module 204 may predict the time that a background processing stream may need to generate a response to the user input. If the predicted time is longer than the threshold time, the parallel streams module 204 may activate the foreground processing steam simultaneously. In some implementations, the parallel streams module 204 may monitor the background processing stream in real time. If the time of the background processing stream reaches the threshold time, the parallel streams module 204 may activate the foreground processing stream to mitigate the latency in the conversation.

The output generation module 206 receives the decision on performing the foreground processing and/or background processing, and proceeds to perform the actions based on the decision that is output from the parallel streams module 204. The output generation module 206 may proceed with the foreground processing stream, and perform actions such as, acknowledging the user's input, confirming receipt of a request, asking a clarifying question, and the like. For instance, if the input is “How do I reset my password?” the output generation module 206 may perform the foreground processing stream and quickly respond with “I can help with that. Are you trying to reset it for security reasons or because you forgot it?” The output generation module 206 may proceed with the background process stream, and perform actions such as, retrieving detailed account information, performing security checks, analyzing transaction histories, preparing personalized recommendations, and the like. For example, when the user says, “I need a detailed statement of my transactions,” while the foreground processing stream acknowledges the request and engages the user with a preliminary response, the background processing stream starts compiling the detailed statement.

In some embodiments, when the foreground processing stream and the background processing streams run in parallel, the output generation module 206 may coordinate the outputs from both streams to ensure a seamless user experience. The output generation module 206 may monitor the completion of the background processing stream and dynamically integrate their results into the ongoing conversation. The output generation module 206 may dynamically adjust its strategy based on the complexity of the query and the expected processing time. For simple questions that require straightforward answers, the output generation module 206 may rely more on the foreground processing stream. For more complex queries, the output generation module 206 may leverage the background processing stream to ensure the response is thorough and accurate, all while keeping the conversation natural and engaging. In one example, after quickly acknowledging a user's request for account information, the output generation module 206 may output an initial response using the foreground processing stream. The initial response may ask for a specific detail (e.g., the last four digits of a social security number). Meanwhile, the output generation module 206 performs the background processing stream to retrieve and prepare the user's account details. Once this information is ready, the output generation module 206 may provide a detailed response to the agent of the declarative agent service 130 for responding to the user. In some implementations, the response may be in text or voice format. The output generation module 206 may perform a text to voice conversion to generate an audio signal as a response to the user in a real-time conversation.

The model training module 212 may apply an iterative process to train a machine-learning model whereby the model training module 212 updates parameter values of machine-learning models based on each of the set of training examples. The training examples may be processed together, individually, or in batches. To train a machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The declarative agent service 130 may use various machine learning models in the parallel processing streams. In one implementation, the machine learning models may be trained on natural language processing tasks. The trained machine learning model may analyze vast amounts of historical voice data to identify patterns and correlations between specific phrases, contexts, sentiments, and the actions taken. By learning from labeled datasets that include diverse user interactions and corresponding triggers, the trained machine learning models may automatically recognize when a new input matches a known trigger pattern. In some embodiments, the machine learning models may be used to dynamically decide which processing stream to activate based on real-time analysis of incoming voice data. By continuously learning from new data and adjusting based on feedback, the machine model may optimize its decision-making process. In some embodiments, the machine learning models may be updated/retrained regularly based on new data and feedback from user interactions.

The data store 214 stores data used by the declarative agent service 130. For example, the data store 214 stores user data, previous conversation, etc. for use by the declarative agent service 130. The data store 214 also stores trained machine-learning models trained by the model training module 212. For example, the data store 214 may store the set of parameters for a trained machine-learning model on one or more non-transitory, computer-readable media. The data store 214 uses computer-readable media to store data, and may use databases to organize the stored data.

### Parallel Processing Streams

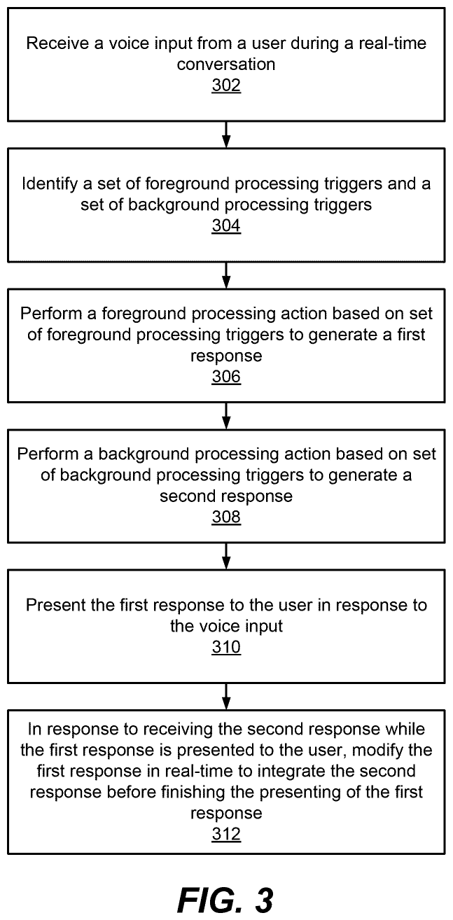

FIG. 3 is a flowchart for a method of generating a response to a voice input with parallel processing streams. Alternative embodiments may include more, fewer, or different steps from those illustrated in FIG. 3, and the steps may be performed in a different order from that illustrated in FIG. 3. These steps may be performed by a declarative agent service 130. In some embodiments, one or more steps may be performed by other components of the declarative agent service environment 100. Additionally, each of these steps may be performed automatically by the declarative agent service 130 or other components without human intervention.

The declarative agent service 130 may receive 302 a voice input from a user during a real-time conversation between an agent of the declarative agent service 130 and the user. In some embodiments, the declarative agent service 130 receives the voice input via an AI agent powered by an LLM of generative AI 140. The declarative agent service 130 may identify 304 a set of foreground processing triggers and a set of background processing triggers. In some embodiments, the declarative agent service 130 identifies one foreground trigger and one background trigger or identifies only foreground triggers or only background triggers.

The declarative agent service 130 may perform 306 a foreground processing action based on the set of foreground processing triggers to generate a first response. Examples of foreground processing actions include acknowledging the user's input, confirming receipt of a request, asking a clarifying question, and the like. The declarative agent service 130 may perform 308 a background processing action based on the set of background processing triggers to generate a second response. For example, a background processing action may be processing a query using an LLM of generative AI 140. In some embodiments, the declarative agent service 130 may perform the foreground processing action and the background processing action in parallel.

The declarative agent service 130 may present 310 the first response to the user in response to the voice input. In some embodiments, the first response is presented completion of the background processing action. In response to receiving the second response while the first response is presented to the user, the declarative agent service 130 may modify 312 the first response in real-time to integrate the second response before finishing the presenting of the first response. In some embodiments, the declarative agent service 130 may present the first response audibly to the user and finish generation of the second response before all of the first response has been presented. For example, the declarative agent service 130 may cause audio of a first sentence to be output, and, before the audio has been completely output, the declarative agent service 130 may add a second sentence after the first sentence in the audio.

In some embodiments, the declarative agent service 130 performs a sentiment analysis operation on the voice input. The declarative agent service 130 may detect a negative sentiment based on the sentiment analysis operation, and the detection of the negative sentiment may be one of the set of background processing triggers. The corresponding background processing action may include facilitating a connection between the user and a human agent and, while initializing the connection, providing feedback to the user via a second foreground processing action.

In some embodiments, in response to determining that the voice input is a partial input, the declarative agent service 130 determines a set of auto-completed sentences starting with the partial input. The declarative agent service 130 may identify a trigger for each auto-completed sentence. Each trigger may be a background processing trigger and associated with one of the set of auto-completed sentences. In some embodiments, at least one trigger of the foreground and background processing triggers is a content-based trigger based on a keyword, phrase, or pattern indicative of a query.

In some embodiments, the first response includes a request for input by the user. The declarative agent service 130 may cause a display associated with the real-time conversation to present a first textual element indicative of the first response. The first textual element may be displayed with one or more interactive elements configured to receive user inputs. The declarative agent service 130 may cause the display to present a second textual element for the second response.

In some embodiments, declarative agent service 130 may cause a display associated with the real-time conversation to present a first textual element of the first response, such as a word in a sentence or a sentence in a paragraph. The declarative agent service 130 may cause the display to present a second textual element, such as a next word or next sentence, for the second response.

In some embodiments, the declarative agent service 130 transcribes the voice input into text. The declarative agent service 130 may remove one or more filler words from the text. A filler word may be a word or sound used to fill pauses or give the user time to think, such as “um,” “uh,” “like,” “you know,” and “well.” The declarative agent service 130 may split the text into standardized tokens and providing the standardized tokens to the agent or an LLM of generative AI 140.

### Computing Machine Architecture

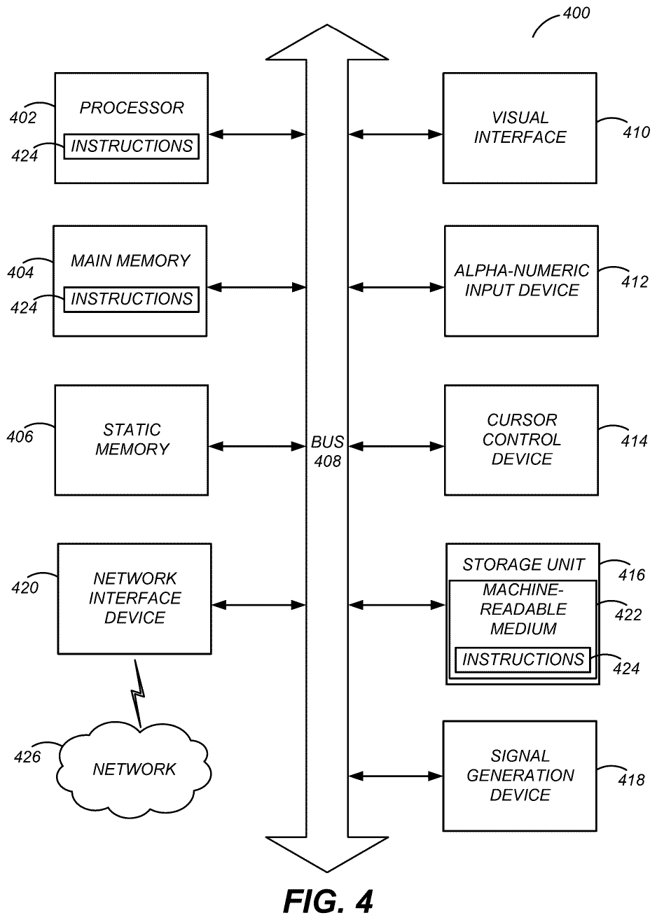

FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by performance, cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a voice input from a user during a real-time conversation between the agent and the user;
identifying, by an agent, one or more triggers based on the voice input and the real-time conversation, the one or more triggers comprising a set of foreground processing triggers and a set of background processing triggers;
performing a foreground processing action based on the set of foreground processing triggers to generate a first response;
performing a background processing action based on the set of background processing triggers to generate a second response;
presenting the first response to the user in response to the received voice input; and
in response to receiving the second response while the first response is presented to the user, modifying the first response in real-time to integrate the second response before finishing the presenting of the first response.

2. The method of claim 1, further comprising:
performing a sentiment analysis operation on the voice input;
detecting a negative sentiment based on the sentiment analysis operation, wherein the detection of the negative sentiment is one of the set of background processing triggers and wherein the background processing action comprises:
facilitating a connection between the user and a human agent; and
while initializing the connection, providing feedback to the user via a second foreground processing action.

3. The method of claim 1, further comprising:
in response to determining that the voice input is a partial input, determining a set of auto-completed sentences starting with the partial input; and
identifying a trigger for each auto-completed sentence, wherein each of the one or more triggers is associated with one of the set of auto-completed sentences.

4. The method of claim 1, wherein the foreground processing action and background processing action are performed in parallel and wherein the first response is presented before a completion of the background processing action.

5. The method of claim 1, wherein the first response includes a request for input by the user, the method further comprising:
causing a display associated with the real-time conversation to present a first textual element of the first response, wherein the first textual element is displayed with one or more interactive elements with which the user can provide input; and
causing the display to present a second textual element for the second response.

6. The method of claim 1, wherein the first response is presented audibly to the user and wherein the generation of the second response is completed before all of the first response has been presented.

7. The method of claim 1, further comprising:
causing a display associated with the real-time conversation to present a first textual element of the first response, wherein the first textual element is display with one or more interactive elements for the user to provide input to; and
causing the display to present a second textual element for the second response.

8. The method of claim 1, further comprising:
transcribing the voice input into text;
removing one or more filler words from the text;
splitting the text into standardized tokens; and
providing the standardized tokens to the agent.

9. The method of claim 1, wherein at least one trigger is a content-based trigger based on a keyword, phrase, or pattern indicative of a query.

10. The method of claim 1, wherein the agent is an artificial intelligence (AI) agent powered by a large language model.

11. A non-transitory computer-readable storage medium storing instructions that, when executed by a processor, cause the processor to perform steps comprising:
receiving, by an agent, a voice input from a user during a real-time conversation between the agent and the user;
identifying, by an agent, one or more triggers based on the voice input and the real-time conversation, the one or more triggers comprising a set of foreground processing triggers and a set of background processing triggers;
performing a foreground processing action based on the set of foreground processing triggers to generate a first response;
performing a background processing action based on the set of background processing triggers to generate a second response;
presenting the first response to the user in response to the received voice input; and
in response to receiving the second response while the first response is presented to the user, modifying the first response in real-time to integrate the second response before finishing the presenting of the first response.

12. The non-transitory computer-readable storage medium of claim 11, the steps further comprising:
performing a sentiment analysis operation on the voice input;
detecting a negative sentiment based on the sentiment analysis operation, wherein the detection of the negative sentiment is one of the set of background processing triggers and wherein the background processing action comprises:
facilitating a connection between the user and a human agent; and
while initializing the connection, providing feedback to the user via a second foreground processing action.

13. The non-transitory computer-readable storage medium of claim 11, the steps further comprising:
in response to determining that the voice input is a partial input, determining a set of auto-completed sentences starting with the partial input; and
identifying a trigger for each auto-completed sentence, wherein each of the one or more triggers is associated with one of the set of auto-completed sentences.

14. The non-transitory computer-readable storage medium of claim 11, wherein the foreground processing action and background processing action are performed in parallel and wherein the first response is presented before a completion of the background processing action.

15. The non-transitory computer-readable storage medium of claim 11, wherein the first response includes a request for input by the user, the steps further comprising:
causing a display associated with the real-time conversation to present a first textual element of the first response, wherein the first textual element is displayed with one or more interactive elements with which the user can provide input; and
causing the display to present a second textual element for the second response.

16. The non-transitory computer-readable storage medium of claim 11, wherein the first response is presented audibly to the user and wherein the generation of the second response is completed before all of the first response has been presented.

17. The non-transitory computer-readable storage medium of claim 11, the steps further comprising:
causing a display associated with the real-time conversation to present a first textual element of the first response, wherein the first textual element is display with one or more interactive elements for the user to provide input to; and
causing the display to present a second textual element for the second response.

18. The non-transitory computer-readable storage medium of claim 11, the steps further comprising:
transcribing the voice input into text;
removing one or more filler words from the text;
splitting the text into standardized tokens; and
providing the standardized tokens to the agent.

19. The non-transitory computer-readable storage medium of claim 11, wherein at least one trigger is a content-based trigger based on a keyword, phrase, or pattern indicative of a query.

20. A system comprising:
a processor; and
a non-transitory computer-readable storage medium storing instructions that, when executed by a processor, cause the processor to perform steps comprising:
receiving, by an agent, a voice input from a user during a real-time conversation between the agent and the user;
identifying, by an agent, one or more triggers based on the voice input and the real-time conversation, the one or more triggers comprising a set of foreground processing triggers and a set of background processing triggers;
performing a foreground processing action based on the set of foreground processing triggers to generate a first response;
performing a background processing action based on the set of background processing triggers to generate a second response;
presenting the first response to the user in response to the received voice input; and
in response to receiving the second response while the first response is presented to the user, modifying the first response in real-time to integrate the second response before finishing the presenting of the first response.
